(19) United States
(12) Patent Application Publication
(10) Pub. No.: US 2023/0162288 A1
(43) Pub. Date: May 25, 2023

(54) INFORMATION PROCESSING APPARATUS, INFORMATION PROCESSING METHOD AND STORAGE MEDIUM

(71) Applicant: HONDA MOTOR CO., LTD., Tokyo (JP)

(72) Inventors: Yoshiaki NEDACHI, Tokyo (JP); Junya ONO, Tokyo (JP)

(21) Appl. No.: 17/966,224

(22) Filed: Oct. 14, 2022

(30) Foreign Application Priority Data
Nov. 22, 2021 (JP) 2021-189584

(51) Int. Cl. G06Q 40/08; H04W 4/02; H04W 4/80; H04W 4/40

(52) U.S. Cl. CPC G06Q 40/08; H04W 4/023; H04W 4/80; H04W 4/40

(57) ABSTRACT

An information processing apparatus acquires, from a communication terminal held by a user, information on the use of a plurality of vehicles owned by the user and determines a premium of an insurance policy covering the plurality of vehicles based on the information on the use of the plurality of vehicles. The information processing apparatus calculates a use level by which each vehicle is used while close to the communication terminal based on the information on the use of the plurality of vehicles, and determines the premium of the insurance policy according to the use level.

### CROSS-REFERENCE TO RELATED APPLICATION(S)

This application claims priority to and the benefit of Japanese Patent Application No. 2021-189584 filed on Nov. 22, 2021, the entire disclosure of which is incorporated herein by reference.

### BACKGROUND OF THE INVENTION

### Field of the Invention

The present invention relates to an information processing apparatus, an information processing method and a storage medium.

### Description of the Related Art

Conventionally, someone who buys a vehicle insurance policy pays a certain amount of a premium during a contract period regardless of how they use a vehicle (for example, use frequency or manner). An invention for calculating a premium according to a use state of a vehicle by a user has been proposed (Japanese Patent Laid-Open No. 2021-51390). Japanese Patent Laid-Open No. 2021-51390 discloses an invention for determining a premium, based on a transition (for example, transition in information such as vehicle type, handling characteristics, characteristics related to acceleration and deceleration, transmission type or vehicle size) of a vehicle driven by a user and for which a premium should be calculated, according to an occurrence probability of an accident for the vehicle driven by the user.

Meanwhile, there are cases where one user owns a plurality of vehicles where they generally pay a premium for the number of vehicles they own. However, since a user is physically a single person, they selectively use vehicles depending on their needs, and thus the vehicles have different use states. That is, it may be economically inefficient for an insured party to be charged the same premium uniformly for a vehicle they do not use frequently.

In addition, since there are vehicles without a communication function with a server, it may be difficult to determine a premium on the basis of the transition of the vehicle as proposed in Japanese Patent Laid-Open No. 2021-51390.

### SUMMARY OF THE INVENTION

The present disclosure has been made in consideration of the aforementioned issues, and realizes a technique capable of properly determining a premium for a user who owns a plurality of vehicles.

In order to solve the aforementioned issues, one aspect of the present disclosure provides an information processing apparatus, comprising: one or more processors; and a memory storing instructions which, when the instructions are executed by the one or more processors, cause the information processing apparatus to function as: an acquisition unit configured to acquire, from a communication terminal held by a user, information on the use of a plurality of vehicles owned by the user; and a determination unit configured to determine a premium of an insurance policy covering the plurality of vehicles based on the information on the use of the plurality of vehicles, wherein the determination unit is configured to calculate a use level by which each vehicle is used while close to the communication terminal based on the information on the use of the plurality of vehicles, and determine the premium of the insurance policy according to the use level.

Another aspect of the present disclosure provides, an information processing method executed by an information processing apparatus, the method comprising: acquiring, from a communication terminal held by a user, information on the use of a plurality of vehicles owned by the user; and determining a premium of an insurance policy covering the plurality of the vehicles based on the information on the use of the plurality of vehicles, wherein the determining includes calculating a use level by which each vehicle is used while close to the communication terminal based on the information on the use of the plurality of vehicles, and determining the premium of the insurance policy according to the use level.

Still another aspect of the present disclosure provides, a non-transitory computer-readable storage medium storing a program for causing a computer to function as each of units included in an information processing apparatus, the information processing apparatus comprising: an acquisition unit configured to acquire, from a communication terminal held by a user, information on the use of a plurality of vehicles owned by the user; and a determination unit configured to determine a premium of an insurance policy covering the plurality of vehicles based on the information on the use of the plurality of vehicles, wherein the determination unit is configured to calculate a use level by which each vehicle is used while close to the communication terminal based on the information on the use of the plurality of vehicles, and determine the premium of the insurance policy according to the use level.

According to the present invention, it is possible to properly determine a premium for a user who owns a plurality of vehicles.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating one example of a premium management system according to a present embodiment of the present invention;

FIG. 2 is a block diagram illustrating a functional configuration example of an information processing server according to the present embodiment;

FIG. 3 is a block diagram illustrating one example of a software configuration of the information processing server according to the present embodiment;

FIG. 4 is a block diagram illustrating a functional configuration example of the vehicle according to the present embodiment;

FIG. 5 is a block diagram illustrating a functional configuration example of a communication terminal according to the present embodiment;

FIG. 6 is a block diagram illustrating a functional configuration example of a service provider device according to the present embodiment;

FIG. 7 is a diagram illustrating one example of a data structure of a user information table according to the present embodiment;

FIG. 8 is a diagram illustrating one example of a data structure of an insurance information table according to the present embodiment;

FIG. 9 is a diagram illustrating one example of a data structure of a use history table according to the present embodiment;

FIG. 10 is a diagram illustrating one example of a data structure of a vehicle information table according to the present embodiment;

FIG. 11 is a flowchart illustrating a series of operations of a premium management process according to the present embodiment; and

FIG. 12 is a flowchart illustrating a series of operations of a premium calculation process according to the present embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

<Configuration of Premium Management System>

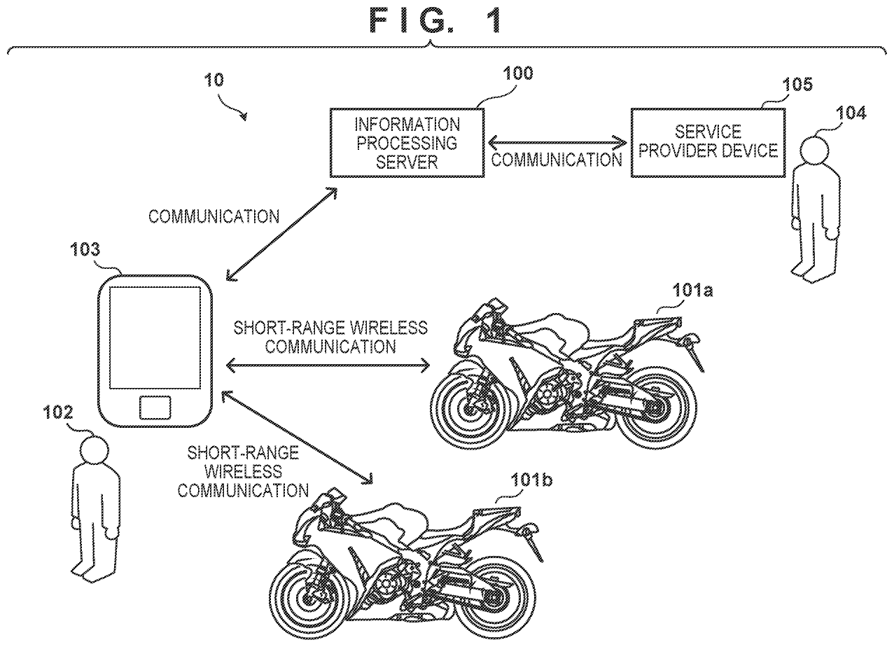

FIG. 1 is a diagram illustrating a configuration example of a premium management system according to the present embodiment. A premium management system 10 according to the present embodiment includes an information processing server 100, a communication terminal 103 used by a user 102, and a vehicle 101a and a vehicle 101b driven by the user 102. Further, the premium management system 10 may further include a service provider device 105 used by an operator 104 of an insurer.

The information processing server 100 is a server managed by a service provider (insurer), performs a premium management process to be described later, and manages a premium that the user 102 should pay. The information processing server 100 acquires information on the use of the vehicle from the communication terminal of the user 102, and determines a premium of the user 102 according to a use level of the vehicle. The user 102 owns a plurality of vehicles, i.e. the vehicles 101a and 101b, and thus they pay a premium for an insurance policy covering the plurality of vehicles. The individual vehicles are simply referred to as, for example, a vehicle 101 unless they are otherwise distinguished.

The service provider is a provider that offers a vehicle insurance policy to the user 102 and other customers. The user 102 buys an insurance policy from the service provider for the plurality of vehicles, and pays, for example, a premium for such an insurance policy every predetermined period (e.g. annually or monthly). The present embodiment will be described referring to a case, for example, where the user 102 makes, every preset period, a deferred payment of a premium corresponding to the use of the vehicle 101 for a predetermined period. However, the user 102 may pay a lump sum of a predetermined premium in advance when a predetermined period commences, and receive a refund or make a payment of an additional premium depending on a use level of the vehicle 101 after the end of the predetermined period. Alternatively, the user 102 may pay a premium for a predetermined period when the predetermined period commences, and a premium for a subsequent predetermined period may be determined according to the use of the vehicle 101 for the predetermined period.

The vehicles 101a and 101b are, for examples, two-wheeled vehicles, but may be other vehicles such as four-wheeled vehicles. The vehicles 101a and 101b may have the same or different engine displacements. The vehicle 101 can communicate with the communication terminal 103 via, for example, short-range wireless communication such as Bluetooth (registered trademark). Meanwhile, the vehicle 101 does not have direct communication with the information processing server 100. The vehicle 101 may be provided with a built-in communication unit capable of using short-range wireless communication (for example, a Bluetooth unit) to establish short-range wireless communication with the communication terminal 103. The vehicle 101 may have an external short-range wireless communication tag attached to the vehicle 101 (by, for example, a car dealer) to establish short-range wireless communication with the communication terminal 103. The communication terminal 103 is paired with the Bluetooth unit or BLE tag in advance. When the user 102 gets on the vehicle 101a while carrying the communication terminal 103, the communication terminal 103 detects that it is close to the Bluetooth unit of the vehicle 101a. In a case where the communication terminal 103 moves (at least a predetermined distance) while periodically detecting that it is close to the vehicle 101a, the communication terminal 103 recognizes that the user 102 is using the vehicle 101a. The built-in communication unit and the external communication tag may be configured to transmit a part of an operation status of the vehicle 101 to the communication terminal 103. For example, the built-in communication unit and the external communication tag may be capable of notifying the communication terminal 103 via short-range wireless communication that the ignition of the vehicle 101 is turned ON/OFF. In order to ensure that the user 102 carries the communication terminal 103 when using the vehicle 101, the communication terminal 103 may be essentially present in vicinity of the vehicle 101 to turn ON the ignition of the vehicle 101.

The communication terminal 103 is, for example, a smartphone held by the user 102, and capable of establishing communication with the information processing server 100 via a communication network. The communication terminal 103 records a use state of the vehicle by recognizing that the vehicle close to the communication terminal 103 is used by the user 102 in a case where the vehicle 101 moves while it periodically detects that it is close to the vehicle 101 (in a case where it is detected that the user is using the vehicle 101). The communication terminal 103 transmits to the information processing server 100 the use state already recorded or being recorded as information on the use of the vehicle. The communication terminal 103 may transmit the information on the use of the vehicle to the information processing server 100 while the user is using the vehicle, or may transmit the information when the user stops the vehicle or later. The information on the use of the vehicle will be described later.

The service provider device 105 is a communication device used by the service provider, and is, for example, a personal computer. The operator 104 operates the service provider device 105 to register, for example, information of the user 102 and information of the insurance policy that the user 102 has bought in the information processing server 100.

<Functional Configuration Example of Information Processing Server>

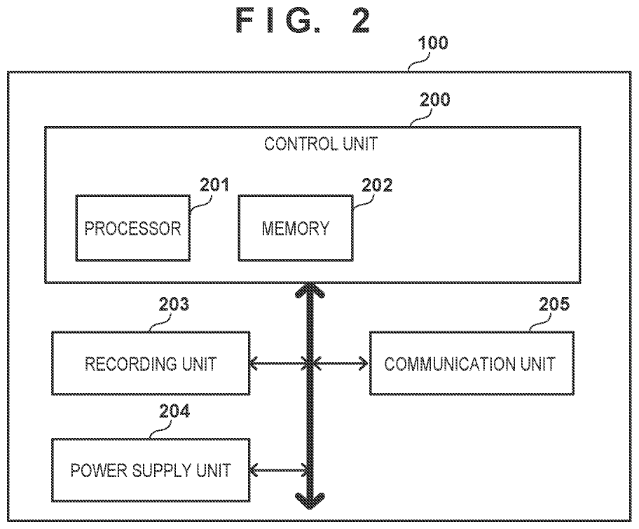

FIG. 2 is a block diagram illustrating a functional configuration example of the information processing server 100 as one example of the information processing apparatus. A control unit 200 includes, for example, one or more processors 201 such as a CPU and a memory 202 such as a RAM. The processor 201 reads and executes a computer program (simply referred to as a “program”) stored in a recording unit 203 to be described later, thereby implementing functions of each unit described later. The control unit 200 may include a graphics processing unit (GPU), an application specific integrated circuit (ASIC) or a dedicated circuit.

The recording unit 203 includes, for example, a non-volatile storage medium such as a semiconductor memory, and stores and reads, for example, various data, a data table to be described later, and programs corresponding to various processes. A power supply unit 204 supplies external power to the information processing server 100. A communication unit 205 is a block for establishing communication with, for example, the communication terminal 103 via a communication network, and is not particularly limited to a specific communication method or protocol.

<Software Configuration of Information Processing Server>

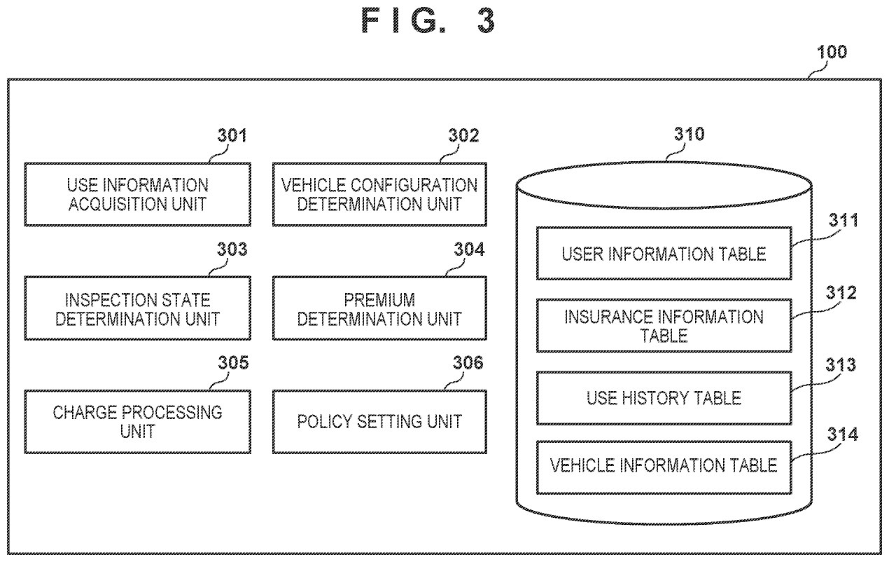

FIG. 3 is a diagram illustrating an example of a software configuration of the information processing server 100 according to the present embodiment. In the present embodiment, the processor 201 reads and executes the program stored in the recording unit 203 to implement each unit. Each of tables 311 to 314 of each database 310 is configured in the recording unit 203. FIG. 3 only shows an example of the software configuration necessary for implementation of the present embodiment, and the software configuration of firmware, an OS, middleware and a web service module is omitted.

A use information acquisition unit 301 acquires the information on the use of the vehicle from the communication terminal 103 via the communication unit 205. Upon receiving the information on the use of the vehicle, the use information acquisition unit 301 records the received information in the use history table 313 of the database 310.

A vehicle configuration determination unit 302 determines a configuration of a short-range wireless communication device included in the vehicle 101. In particular, for example, it is determined whether the vehicle 101 includes a built-in short-range wireless communication device (Bluetooth unit) or an external short-range wireless communication device (BLE tag). The determination is a determination for reliability of the vehicle, and is used in calculation of the insurance premium to be described later.

An inspection state determination unit 303 determines whether an inspection on the vehicle 101 has been performed within a predetermined period. The determination is a determination for reliability of the vehicle, and is used in calculation of the insurance premium to be described later, similarly to the configuration of short-range wireless communication.

A premium determination unit 304 determines a premium for an insurance policy covering a plurality of vehicles according to a use level of the vehicle 101 by the user 102. A method of determining the premium will be described later when describing operations of a premium calculation process.

A charge processing unit 305 charges the user 102 the premium. For example, in a case where the user 102 makes a deferred payment of the premium every predetermined period, the user 102 is charged the premium corresponding to the use of the vehicle 101 for the predetermined period (that is, the premium determined by the premium determination unit 304). The premium may be charged by sending a payment request to the communication terminal 103 held by the user 102, and may be paid by a predetermined payment method (not shown).

A policy setting unit 306 receives registration of a new user or a policy update request for a user who has already bought a policy from the service provider device 105, and adds or updates various table in the database.

The database 310 holds tables containing various data necessary for a premium management process. The database 310 includes, for example, a user information table 311, an insurance information table 312, a use history table 313, and a vehicle information table 314.

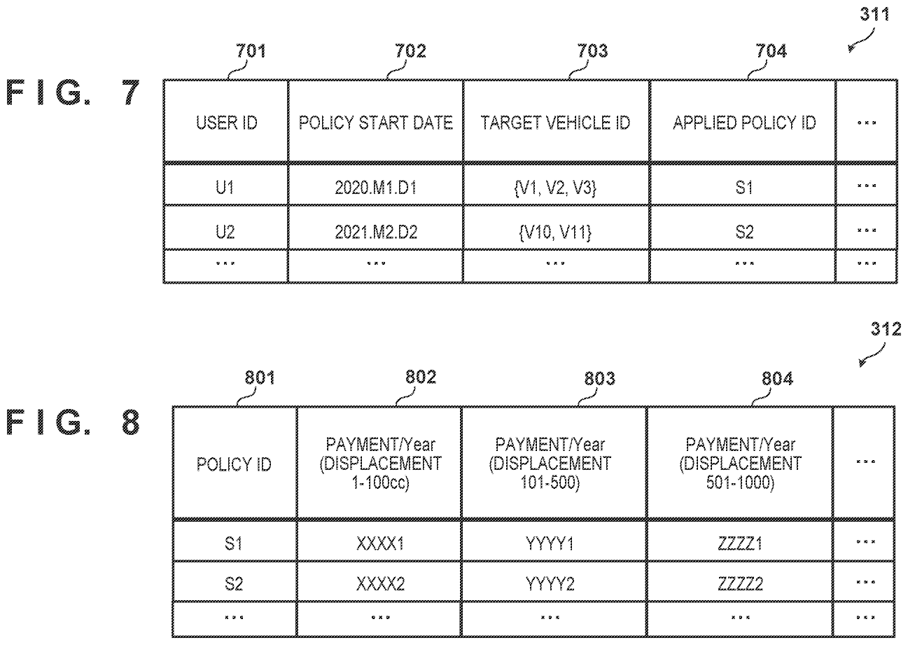

The user information table 311 has, for example, a data structure as illustrated in FIG. 7. The user information table 311 includes, for example, a user ID 701, a policy start date 702, a target vehicle ID 703, and an applied policy ID 704. The user ID 701 is an identifier of a user who buys an insurance policy. The policy start date 702 is a date on which the user buys the insurance policy, and indicates a renewal date in a case where the user renews the policy every predetermined period. The target vehicle ID 703 is a list of identifiers of vehicles owned by the user and covered by the insurance policy. That is, a user with a user ID U1 owns vehicles with identifiers V1, V2 and V3, and these vehicles are covered by a policy. The applied policy ID indicates identification information of a policy that the user has bought.

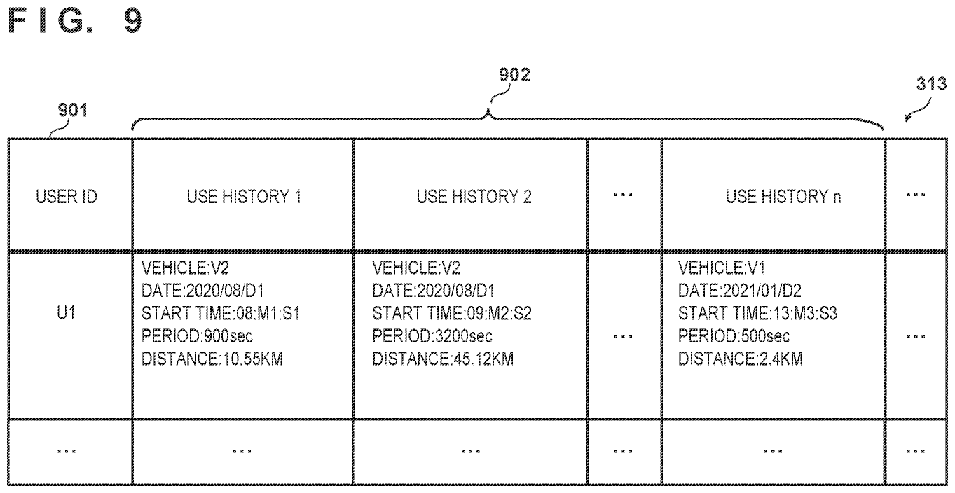

The insurance information table 312 has, for example, a data structure as illustrated in FIG. 8. The insurance information table 312 includes a policy ID 801 and premiums 802 to 804 by engine displacement, and indicates how much premium is charged for each vehicle size class (for example, displacement) in the insurance policy that the user 102 has bought. The policy ID 801 indicates an ID of the insurance policy that the user 102 has bought and covers a plurality of vehicles. The premiums 802 to 804 respectively indicate an annual amount for each vehicle size class. For example, a premium set for engine displacement is lower as the displacement is smaller. That is, an insurance policy with a policy ID of Si has a premium scheme of XXXX1<YYYY1<ZZZZ1. For better understanding, the present embodiment shows the example where the premium is set according to the vehicle size class only; however, the premium can be determined based on other factors, including a vehicle type, a year of manufacturer and the age of the user.

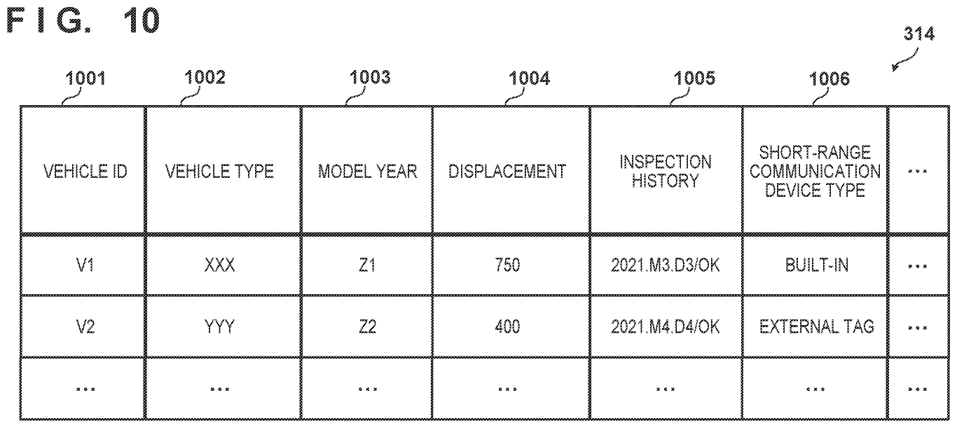

The use history table 313 has a data structure as illustrated in FIG. 9. The use history table 313 is a table in which a use history of a vehicle for each user is recorded. A user ID 901 is an identifier for identifying a user, and a use history 902 (use histories 1 to n) represents a use history of a vehicle for each use. As described above, “one use” is determined as that, for example, when the ignition of the vehicle 101 is turned ON in a state where it is detected that the communication terminal 103 is close to the vehicle 101 and then the vehicle travels (moves) a predetermined distance (for example, 10 m), one travel is started. It is assumed that one travel ends when the ignition of the vehicle 101 is turned OFF in a state where it is detected that the communication terminal 103 is close to the vehicle 101. The communication terminal 103 detects the start and end of one travel, records a date, time, period (for example, second), and traveling distance (for example, km) of the travel start, and transmits the recorded information to the information processing server 100 as the information on the use of the vehicle. The communication terminal 103 may transmit the information on the use of the vehicle to the information processing server 100 when or after the user stops the vehicle, or may transmit the information on the use of the vehicle to the information processing server 100 in real time as the vehicle is traveling. The communication terminal 103 may transmit a date and time of the travel start, location information, and a date and time of the travel end in real time, and the server may calculate and record a period and a distance in the use history.

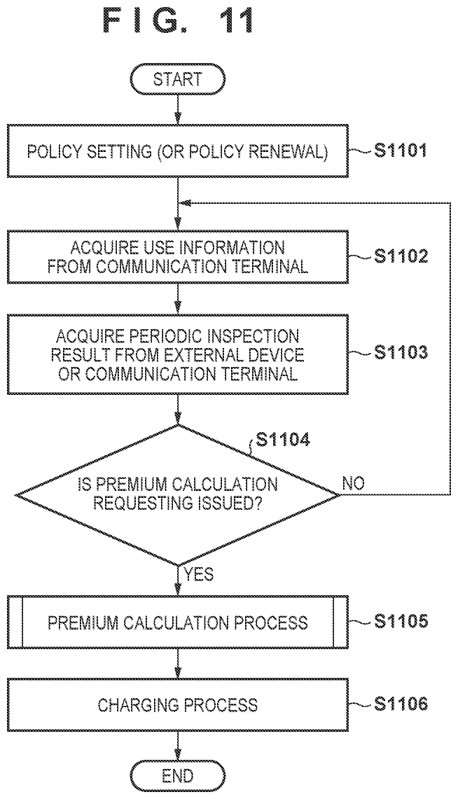

The vehicle information table 314 has a data structure as illustrated in FIG. 10. The vehicle information table 314 is a table that holds vehicle information of the vehicle owned by the user 102, and includes a vehicle ID 1001, a vehicle type 1002, a model year 1003, a displacement 1004, an inspection history 1005, and a short-range communication device type 1006. The vehicle ID 1001 is an identifier for identifying a vehicle. A vehicle type 1002 indicates a model of the vehicle 101, and a model year 1003 indicates a model year of the vehicle 101. The displacement 1004 indicates an engine displacement (vehicle size class) of the vehicle. The inspection history 1005 indicates the latest date of inspection and the results (acceptable or unacceptable). In the present embodiment, the inspection history data represents that it is inspected that the BLE tag is not tampered mainly in a case where the short-range communication device type is an external device. In particular, the external communication tag may be more vulnerable to tampering by replacement than the built-in communication unit. Therefore, the inspection checks, for example, whether a tag of a vehicle with a higher vehicle size class (displacement) is replaced with a tag for a lower vehicle size class for tampering to deceive as if the vehicle with a lower vehicle size class is used while the vehicle with a higher vehicle size class is actually used. As will be described later, if no problem is found in the inspection of the external communication unit, the premium is calculated in the same manner as the premium calculation for a vehicle with the built-in communication unit.

<Functional Configuration Example of Vehicle>

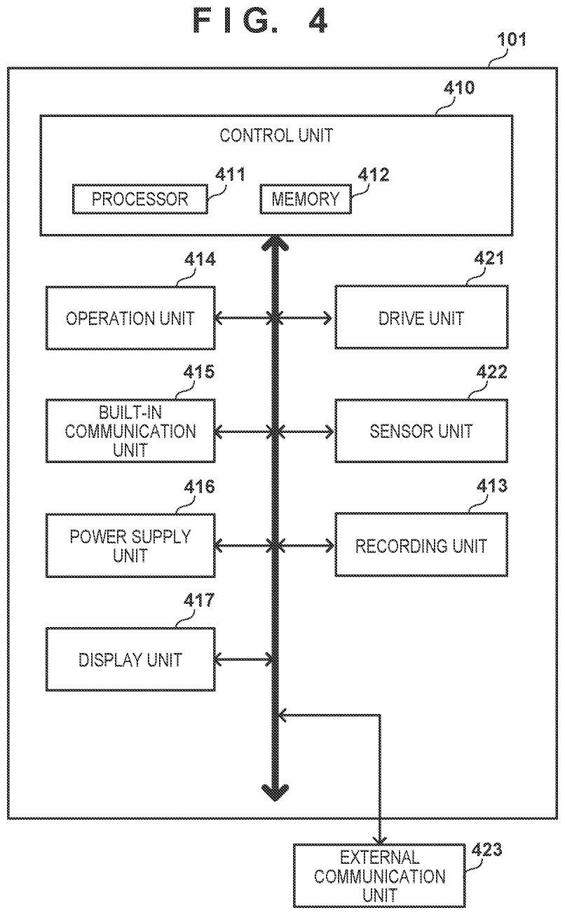

A functional configuration example of the vehicle 101 will be described below. FIG. 4 is a block diagram illustrating a functional configuration example of the vehicle 101. A control unit 410 includes one or more processors 411 and a memory 412. The processor 411 reads and executes programs stored in a recording unit 413 to implement various functions of the vehicle. The memory 412 is a volatile storage area, and is used as, for example, a working memory. The control unit 410 may further include a GPU, ASIC or dedicated circuit.

The recording unit 413 is a non-volatile storage area (for example, a semiconductor memory) and stores programs corresponding to various types of processing.

Each block to be described below operates under the control of the control unit 410. An operation unit 414 is a part that receives various operations on the vehicle, and includes, for example, a switch and a touchscreen. In the present embodiment, the operation unit 414 receives, for example, input of turning ON/OFF the ignition.

A built-in communication unit 415 is one example of a short-range wireless communication device included in the vehicle 101. The built-in communication unit 415 is a built-in communication unit capable of using short-range wireless communication (for example, a Bluetooth unit) to establish short-range wireless communication with the communication terminal 103.

A power supply unit 416 is a block that supplies power to each unit of the vehicle 101 and corresponds to, for example, a battery. A display unit 417 is a block for outputting various types of information such as operation menus and map data for navigation, and includes, for example, a display. The display unit 417 and the operation unit 414 may be integrally configured as, for example, a touchscreen display.

A drive unit 421 is a block that causes the vehicle to travel, and may include, for example, an actuator, tires, a motor and an engine. A sensor unit 422 includes various sensors for acquiring a speed and acceleration of the vehicle. Examples of the sensors may include a speed sensor, an acceleration sensor, an infrared sensor, and an image sensor. The sensors may be provided according to information to be acquired. The vehicle 101 may transmit necessary information to the communication terminal 103 for measurement of a traveling distance in the communication terminal 103.

An external communication unit 423 is one example of a short-range wireless communication device included in the vehicle. The external communication unit 423 is attached to the vehicle when the vehicle does not include the built-in communication unit 415. That is, the vehicle 101 of the present embodiment includes either the built-in short-range wireless communication device or the external short-range wireless communication device, that is, either the built-in communication unit 415 or the external communication unit 423. The external communication unit 423 includes, for example, an external short-range wireless communication tag (for example, a BLE tag).

<Functional Configuration Example of Communication Terminal>

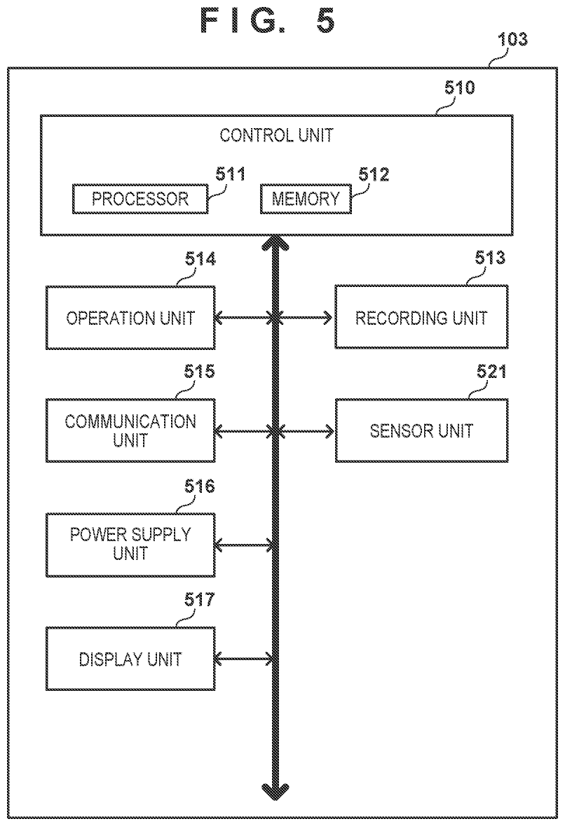

A functional configuration example of the communication terminal 103 will be described below as one example of the communication device. FIG. 5 is a block diagram illustrating a functional configuration example of the communication terminal 103. A control unit 510 includes one or more processors 511 and a memory 512. The processor 511 reads and executes programs stored in a recording unit 513 to implement functions of various blocks in the communication terminal 103. The memory 512 is a volatile storage medium, and is used as, for example, a working memory. The control unit 510 may be configured by a GPU, ASIC or dedicated circuit.

The recording unit 513 is a non-volatile storage medium (for example, a semiconductor memory) and stores programs to implement functions of various blocks.

The communication terminal 103 according to the present embodiment includes an interface of information for the outside and various blocks that provide, for example, power necessary for the operation of the communication terminal 103. Each block to be described below operates under the control of the control unit 510. An operation unit 514 is a block that receives various operations on the communication device, and includes, for example, a switch and a touch panel. In the present embodiment, the operation unit 514 receives, for example, activation and operation of applications recorded in the recording unit 513.

A communication unit 515 is a block for establishing communication with an external device (for example, the information processing server 100) via a network, and is not particularly limited a specific communication method or protocol. Furthermore, a communication unit is further provided to establish short-range wireless communication with the vehicle 101. For example, the communication unit 515 transmits, for example, the information on traveling of the vehicle 101 to the information processing server 100, and detects that it is close to the vehicle 101.

A power supply unit 516 is a block that supplies power to each part of the communication terminal 103 and corresponds to, for example, a battery. A display unit 517 is a block for outputting various types of information such as operation menus of the application, and includes, for example, a display. The display unit 517 and the operation unit 514 may be integrally configured as, for example, a touchscreen display.

A sensor unit 521 includes various sensors such as a global positioning system (GPS) for detecting its own position information and a camera.

<Functional Configuration Example of Service Provider Device>

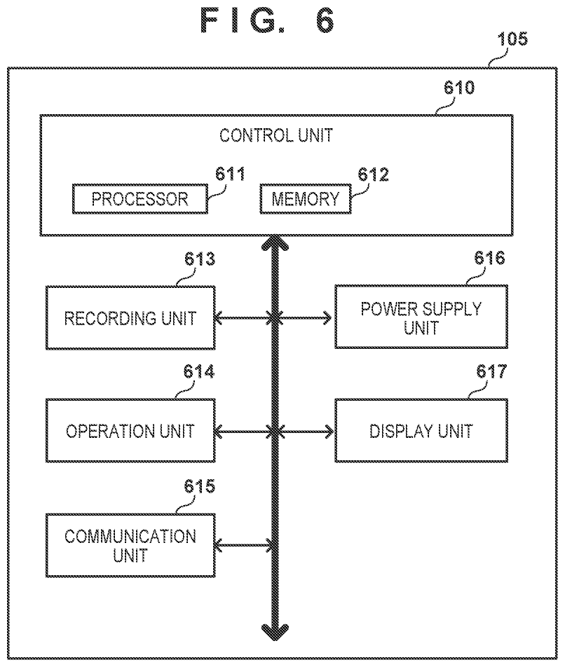

A functional configuration example of the service provider device 105 will be described below as one example of the external device. FIG. 6 is a block diagram illustrating a functional configuration example of the service provider device 105. A control unit 610 includes one or more processors 611 and a memory 612. The processor 611 reads and executes programs stored in a recording unit 613 to implement various functions of the service provide device. The memory 612 is a volatile storage medium (for example, semiconductor memory), and is used as, for example, a working memory.

The recording unit 613 is a non-volatile storage medium (for example, a semiconductor memory) and stores programs to implement functions of various blocks.

The service provider device 105 according to the present embodiment includes an interface of information for the outside and various blocks that provide, for example, power necessary for the operation of the service provider device 105. Each part to be described below operates under the control of the control unit 610.

An operation unit 614 is a part that receives various operations on the service provider device, and includes, for example, a mouse, a keyboard, and a touchscreen. In the present embodiment, the operation unit 614 receives operations for registering or updating the insurance policy when the user has bought or renewed the insurance policy.

A communication unit 615 is a block for establishing communication with an external device (for example, the information processing server 100) via a network, and is not particularly limited a specific communication method or protocol. For example, the communication unit 615 transmits a registration request and a renewal request when the user has bought or renewed the insurance policy to the information processing server 100, and receives display information on registration/renewal results from the information processing server 100.

A power supply unit 616 is a block that supplies power to each part of the service provider device 105 and corresponds to, for example, a battery. A display unit 617 is a block for outputting various types of information such as operation menus, and includes, for example, a display.

<Series of Operations for Premium Management Process>

Referring to FIG. 11, a premium management process in the information processing server 100 will be described below. A series of operations for the premium management process is implemented by the processor 201 in the control unit 200 of the information processing server 100 executing a program stored in the recording unit 203. Each step of the following process may be actually executed by each unit illustrated in FIG. 3, but for streamlined description, each processing will be described as being executed by the control unit 200.

In S1101, the control unit 200 newly sets an insurance policy for the user 102. For example, the control unit 200 receives a policy setting request for the user 102 from the service provider device 105, and sets the user information table 311, the use history table 313, and the vehicle information table 314 according to the setting request. The policy setting request may be application for policy renewal instead of newly setting the policy. In this case, the control unit 200 updates the policy start date 702 of the user information table 311 according to the renewal date. By this step, the insurance policy of the user 102 becomes effective, and the information processing server 100 accumulates the history information of the user 102.

In S1102, the control unit 200 acquires information on the use of the vehicle by the user from the communication terminal 103. As described above, the information on the use of the vehicle by the user includes, for example, information on the date, time, period (for example, second), and traveling distance (for example, km) of the travel start. The control unit 200 stores the acquired information on the use of the vehicle in the use history table 313. The information on the use of the vehicle by the user is transmitted from the communication terminal 103, for example, when the user completes one travel.

In S1103, for example, when an inspection result is transmitted from the communication terminal 103 or the external device such as the service provider device 105, the control unit 200 acquires the inspection result. As described above, the inspection includes the inspection on whether tampering is not performed, such as replacement of the external tag. When acquiring the inspection result, the control unit 200 rewrites the inspection history 1005 of the vehicle information table 314.

In S1104, the control unit 200 determines whether a command for requesting premium calculation has been issued. For example, a premium calculation request for the user is set to be issued at a timing when a predetermined number of days elapse from the policy start date of the user (to determine the premium for the user). In this case, when accepting the premium calculation request, the control unit 200 starts processing to calculate the premium for the user. The premium calculation process is not limited to the description above, and for example, may be executed when a request of confirming the premium is received from the communication terminal 103 of the user 102.

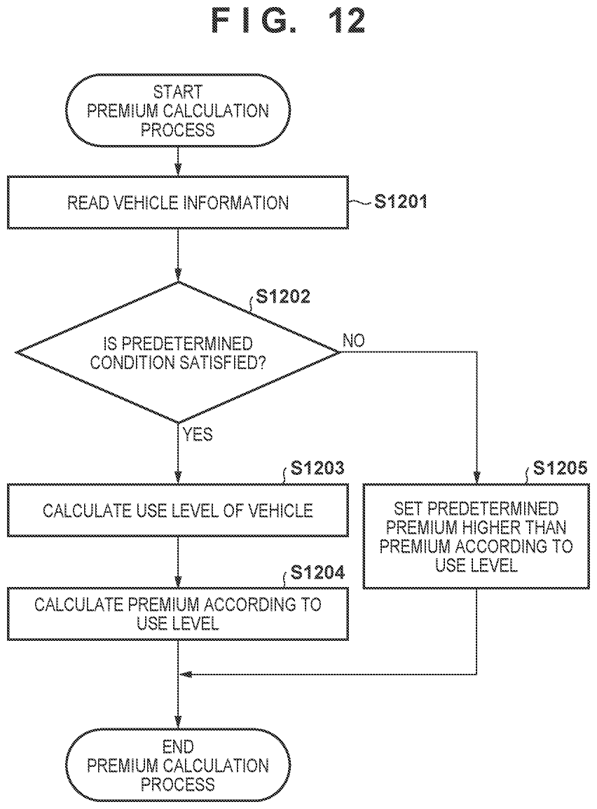

In S1105, the control unit 200 calculates the premium according to a use level of the vehicle by the user 102. The premium calculation process will be described later with reference to FIG. 12.

In S1106, the control unit 200 executes a premium charging process according to the premium for the user 102 calculated by the premium calculation process in S1105. In the premium charging process, a billing email indicating the premium may be transmitted to the communication terminal 103 of the user, or the premium may be automatically withdrawn from a bank account designated by the user in advance. When the premium charging process is completed, the control unit 200 ends this series of operations.

In the present embodiment, a case where the user makes a deferred payment of the premium according to the use level of the user's vehicle has been described as an example. For example, in a case where the user 102 makes a deferred payment of the premium every predetermined period, the control unit 200 charges the user 102 the premium corresponding to the use of the vehicle 101 for the predetermined period (that is, the premium determined by the premium determination unit 304). On the other hand, the premium management process is applicable not only to the deferred payment but also to other payment methods. For example, the control unit 200 may receive prepayment of a predetermined amount (for example, the amount corresponding to a vehicle with the highest vehicle size class) at the start of a predetermined period. In this case, the control unit 200 may calculate the premium according to the use level of the vehicle(s) after the end of the predetermined period, and in a case where the premium calculated in S1105 is less than the amount paid in advance, the amount in excess may be refunded. In a case where the premium calculated in S1105 exceeds the amount paid in advance, the user may make an additional payment. Alternatively, the control unit 200 may provide the user with the premium calculated in S1105 as the premium for the next period. For example, in a case where the user make a payment of the premium for the current predetermined period at the start of the current predetermined period, the control unit 200 may determine the premium corresponding to the use of the vehicle 101 in the current predetermined period (the premium calculated in S1105) as the insurance premium for the next predetermined period.

<Series of Operations for Premium Calculation Process>

Referring to FIG. 12, a series of operations related to a premium calculation process in the information processing server 100 will be described below. This process is also implemented by the processor 201 in the control unit 200 of the information processing server 100 executing a program stored in the recording unit 203. Each step of the following process may be actually executed by each unit illustrated in FIG. 3, but for streamlined description, each processing will be described as being executed by the control unit 200.

In S1201, the control unit 200 reads the vehicle information of a target vehicle from the vehicle information table 314. For example, in a case where the number of vehicles owned by the user and to be covered by the policy is three, vehicle information of the three vehicles is read out. The control unit 200 acquires information such as the displacement 1004, the inspection history 1005, and the short-range communication device type 1006 in the vehicle information of each vehicle.

In S1202, the control unit 200 determines whether the target vehicle satisfies a predetermined condition. For example, the control unit 200 determines whether there is a vehicle that does not use the built-in short-range wireless communication device among the plurality of vehicles, and determines that the predetermined condition is not satisfied when there is a vehicle that does not use the built-in short-range wireless communication device (for example, when it is using the external short-range wireless communication device). This is because the external short-range wireless communication device may be more vulnerable to tampering by replacement than the built-in short-range wireless communication device, and thus, in a case where all vehicles use the built-in short-range wireless communication device, the premium can be calculated corresponding to the actual use level. When it is determined that the target vehicle satisfies the predetermined condition, the control unit 200 advances the processing to S1203, and otherwise proceeds the processing to S1205.

The control unit 200 may add a further condition to the predetermined condition to determine whether there is a vehicle that does not use the built-in short-range wireless communication device among the plurality of vehicles. For example, in a case where there is a vehicle using the external short-range wireless communication device among the plurality of vehicles, the control unit 200 may further refer to the inspection history 1005 to determine whether the inspection has been performed on the vehicle of interest. That is, even in a case where a vehicle using an external short-range wireless communication device is included, but the inspection history 1005 indicates that the inspection has been performed on the vehicle in interest, the control unit 200 may determine that the predetermined condition is satisfied the same as in a case where all vehicles include the built-in short-range wireless communication device. For example, in a case where the latest inspection date described in the inspection history 1005 is within a predetermined period and the result is acceptable, the control unit 200 can determine that it indicates that the inspection has performed on the vehicle of interest. If the inspection has been performed, the external short-range wireless communication device is unlikely to be tampered. Therefore, when the inspection has been performed, it can be handled in the same manner as in a case where the built-in short-range wireless communication device is used.

In addition to the determination above, the control unit 200 may add a further condition to the predetermined condition. For example, in a case where there is a vehicle using the external short-range wireless communication device among the plurality of vehicles, the control unit 200 may further determine whether the plurality of vehicles fall within a predetermined range of vehicle size class. That is, in a case where there is a vehicle using the external short-range wireless communication device among the plurality of vehicles, but referring to the displacement 1004, it is determined that the plurality of vehicles fall within the predetermined range of vehicle size class, the control unit 200 may determine that the predetermined condition is satisfied the same as in a case where all vehicles include the built-in short-range wireless communication device. For example, the control unit 200 calculates a displacement difference between a vehicle having the maximum displacement and a vehicle having the minimum displacement described in the displacement 1004, and when the difference is equal to or less than a predetermined value (for example, no difference), the control unit 200 determines that the plurality of vehicles fall within the predetermined range of vehicle size class. In a case where the displacement difference is not so large, a premium difference according to the use level is small in the first place; therefore it may be handled in the same manner as in a case where the built-in short-range wireless communication device is used.

In S1203, the control unit 200 calculates the use level while close to the communication terminal of each vehicle on the basis of the information in the use history of each vehicle. The use level may be the number of times each of the plurality of vehicles has been used while close to the communication terminal. For example, the control unit 200 may count the number of times of use for each vehicle with reference to the use history table 313 illustrated in FIG. 9. As described above, the use histories 1 to n in the use history table 313 illustrated in FIG. 9 indicate the use history of the vehicle for each use. Each use history is defined as that, for example, the ignition of the vehicle 101 is turned ON in a state where it is detected that the communication terminal 103 is close to the vehicle 101 and then the vehicle travels (moves) a predetermined distance (for example, 10 m). Therefore, the control unit 200 may count how many times each vehicle has been used with reference to the use histories 1 to n.

In S1204, the control unit 200 determines the premium according to the use level on the basis of the use level calculated in S1203. In a case where the number of times of use is a, b or c for vehicle A, B or C, respectively, the control unit 200 calculates the premium as follows.

Premium=premium for vehicle size class of vehicle A×a/(a+b+c)+premium for vehicle size class of vehicle B×b/(a+b+c)+premium for vehicle size class of vehicle C×c/(a+b+c) (Equation 1)

This premium calculation is one example, and other calculation methods may be adopted as long as the premium reflecting the use level can be calculated. The calculated premium may be multiplied by a predetermined constant or be offset. The premium of the insurance policy covering three vehicles may be substantially close to, for example, a premium for two vehicles.

In the example above, the case where the use level of the vehicle is represented by the number of times of use has been described, but the use level may be expressed by other values. For example, the use level may be represented by a traveling distance or time for which each of the plurality of vehicles has been used while close to the communication terminal. The use histories 1 to n in the use history table 313 each record a period and a distance when the ignition of the vehicle 101 is turned ON in a state where it is detected that the communication terminal 103 is close to the vehicle 101 and then the vehicle travels (moves) a predetermined distance (for example, 10 m). For example, the control unit 200 may sum periods (that is, traveling times) of a specific vehicle in the use histories 1 to n of the use history table 313. For example, the control unit 200 may sum distances (that is, traveling distances) of a specific vehicle in the use histories 1 to n of the use history table 313. If the summed numerical values are used instead of a, b, and c in the equation above, the premium can be calculated according to the traveling time or the traveling distance.

In S1205, the control unit 200 sets a predetermined premium higher than the premium according to the use level. For example, in a case where the premium calculated in S1204 falls substantially around a premium for one vehicle, the control unit 200 sets a premium of the vehicle with the highest premium as the premium of this step. Of course, the premium set in this step can be set in advance according to a distribution of the premium calculated in S1204. When setting the insurance premium, the control unit 200 ends the series of processing and returns to a caller.

As described above, in the present embodiment, the information processing server 100 acquires information on the use of the plurality of vehicles owned by the user 102 from the communication terminal 103 held by the user 102, and determines the premium of the insurance policy covering the plurality of vehicles on the basis of the information on use of the plurality of vehicles. The information processing server 100 calculates the use level of each vehicle while close to the communication terminal on the basis of the information on the use of the plurality of vehicles, and determines the premium of the insurance policy according to the use level. Accordingly, it is possible to determine a premium suitable for a user who owns a plurality of vehicles, unlike a case where a uniform premium is imposed on each vehicle.

### Summary of Embodiments

1. An information processing apparatus (for example, 100) in the above embodiments, comprising:

one or more processors; and

a memory storing instructions which, when the instructions are executed by the one or more processors, cause the information processing apparatus to function as:

an acquisition unit (for example, 301) configured to acquire, from a communication terminal (for example, 103) held by a user (for example, 102), information on the use of a plurality of vehicles (for example, 101) owned by the user; and

a determination unit (for example, 304) configured to determine a premium of an insurance policy covering the plurality of vehicles based on the information on the use of the plurality of vehicles,

wherein the determination unit is configured to calculate a use level by which each vehicle is used while close to the communication terminal based on the information on the use of the plurality of vehicles, and determine the premium of the insurance policy according to the use level (for example, S1203, S1204).

According to this embodiment, it is possible to determine a premium suitable for a user who owns a plurality of vehicles, unlike a case where a uniform premium is imposed on each vehicle.

2. In the information processing apparatus in the above embodiments, wherein the use level indicates the number of times that each of the plurality of vehicles is used while close to the communication terminal.

According to this embodiment, the premium can be calculated according to the number of times of the use of each vehicle.

3. In the information processing apparatus in the above embodiments, wherein the use level indicates a traveling distance or a traveling time that each of the plurality of vehicles is used while close to the communication terminal.

According to this embodiment, the premium can be calculated according to the traveling distance or the traveling time of each vehicle. As compared to the number of times of the use, in a case where one use time or one travel distance is longer, it is possible to calculate the premium more accurately in accordance with the use state of each vehicle.

4. In the information processing apparatus in the above embodiments, wherein

each vehicle includes either a built-in short-range wireless communication device or an external short-range wireless communication device,

a state in which the vehicle is close to the communication terminal is detected by short-range wireless communication between the communication terminal and the built-in short-range wireless communication device or the external short-range wireless communication device, and

the determination unit is configured to adjust the premium depending on whether there is a vehicle that does not use the built-in short-range wireless communication device among the plurality of vehicles.

According to this embodiment, it is possible to advantageously control the premium calculation based on the use level according to the use level depending on whether the highly reliable short-range wireless communication device is used.

5. In the information processing apparatus in the above embodiments, wherein the determination unit is configured to, in a case where there is a vehicle that does not use the built-in short-range wireless communication device among the plurality of vehicles, increase the premium compared to that in a case where there is no vehicle that does not use the built-in short-range wireless communication device among the plurality of vehicle.

According to this embodiment, it is possible to offer advantages in the premium calculated based on the use level to the user who uses the highly reliable short-range wireless communication device.

6. In the information processing apparatus in the above embodiments, wherein the determination unit is configured to, in a case where the plurality of vehicles fall within a predetermined range of vehicle size class, determine the premium equivalent to a premium in a case where the communication terminal establishes communication with all the vehicles by the built-in short-range wireless communication device.

According to this embodiment, in a case where there is a vehicle using the external short-range wireless communication device among a plurality of vehicles, but a premium difference depending on the use level is relatively low in the first place, it can be handled in the same manner as a case where the built-in short-range wireless communication device is used.

7. In the information processing apparatus in the above embodiments, wherein the acquisition unit is configured to acquire information on an inspection performed on the plurality of vehicles from an external device or the communication terminal, and

the determination unit is configured to, in a case where the information indicates that the inspection is being performed on the plurality of vehicles, determine the premium equivalent to a premium in a case where the communication terminal establishes communication with all the vehicles by the built-in short-range wireless communication device.

According to this embodiment, in a case where the external short-range wireless communication device is used but the inspection has been performed, a possibility of tampering is extremely low, thus it is possible to advantageously control the premium calculation based on the use level. It is also possible to motivate the user to perform the inspection.

8. In an information processing method executed by an information processing apparatus in the above embodiments, the method comprising:

acquiring, from a communication terminal held by a user, information on the use of a plurality of vehicles owned by the user; and

determining a premium of an insurance policy covering the plurality of the vehicles based on the information on the use of the plurality of vehicles,

wherein the determining includes calculating a use level by which each vehicle is used while close to the communication terminal based on the information on the use of the plurality of vehicles, and determining the premium of the insurance policy according to the use level.

According to this embodiment, it is possible to determine a premium suitable for a user who owns a plurality of vehicles, unlike a case where a uniform premium is imposed on each vehicle.

The invention is not limited to the foregoing embodiments, and various variations/changes are possible within the spirit of the invention.

What is claimed is:

1. An information processing apparatus, comprising:
one or more processors; and
a memory storing instructions which, when the instructions are executed by the one or more processors, cause the information processing apparatus to function as:
an acquisition unit configured to acquire, from a communication terminal held by a user, information on the use of a plurality of vehicles owned by the user; and
a determination unit configured to determine a premium of an insurance policy covering the plurality of vehicles based on the information on the use of the plurality of vehicles,
wherein the determination unit is configured to calculate a use level by which each vehicle is used while close to the communication terminal based on the information on the use of the plurality of vehicles, and determine the premium of the insurance policy according to the use level.

2. The information processing apparatus according to claim 1, wherein the use level indicates the number of times that each of the plurality of vehicles is used while close to the communication terminal.

3. The information processing apparatus according to claim 1, wherein the use level indicates a traveling distance or a traveling time that each of the plurality of vehicles is used while close to the communication terminal.

4. The information processing apparatus according to claim 1, wherein
each vehicle includes either a built-in short-range wireless communication device or an external short-range wireless communication device,
a state in which the vehicle is close to the communication terminal is detected by short-range wireless communication between the communication terminal and the built-in short-range wireless communication device or the external short-range wireless communication device, and
the determination unit is configured to adjust the premium depending on whether there is a vehicle that does not use the built-in short-range wireless communication device among the plurality of vehicles.

5. The information processing apparatus according to claim 4, wherein the determination unit is configured to, in a case where there is a vehicle that does not use the built-in short-range wireless communication device among the plurality of vehicles, increase the premium compared to that in a case where there is no vehicle that does not use the built-in short-range wireless communication device among the plurality of vehicle.

6. The information processing apparatus according to claim 5, wherein the determination unit is configured to, in a case where the plurality of vehicles fall within a predetermined range of vehicle size class, determine the premium equivalent to a premium in a case where the communication terminal establishes communication with all the vehicles by the built-in short-range wireless communication device.

7. The information processing apparatus according to claim 5, wherein the acquisition unit is configured to acquire information on an inspection performed on the plurality of vehicles from an external device or the communication terminal, and
the determination unit is configured to, in a case where the information indicates that the inspection is being performed on the plurality of vehicles, determine the premium equivalent to a premium in a case where the communication terminal establishes communication with all the vehicles by the built-in short-range wireless communication device.

8. An information processing method executed by an information processing apparatus, the method comprising:
acquiring, from a communication terminal held by a user, information on the use of a plurality of vehicles owned by the user; and
determining a premium of an insurance policy covering the plurality of the vehicles based on the information on the use of the plurality of vehicles,
wherein the determining includes calculating a use level by which each vehicle is used while close to the communication terminal based on the information on the use of the plurality of vehicles, and determining the premium of the insurance policy according to the use level.

9. A non-transitory computer-readable storage medium storing a program for causing a computer to function as each of units included in an information processing apparatus, the information processing apparatus comprising:
an acquisition unit configured to acquire, from a communication terminal held by a user, information on the use of a plurality of vehicles owned by the user; and
a determination unit configured to determine a premium of an insurance policy covering the plurality of vehicles based on the information on the use of the plurality of vehicles,
wherein the determination unit is configured to calculate a use level by which each vehicle is used while close to the communication terminal based on the information on the use of the plurality of vehicles, and determine the premium of the insurance policy according to the use level.
